(19) United States
(12) Patent Application Publication
(10) Pub. No.: US 2018/0261170 A1
(43) Pub. Date: Sep. 13, 2018

(54) LIQUID CRYSTAL DISPLAY DEVICE AND METHOD OF CONTROLLING LIQUID CRYSTAL DISPLAY DEVICE

(71) Applicant: Sharp Kabushiki Kaisha, Sakai City, Osaka (JP)

(72) Inventor: MAKOTO SHIOMI, Sakai City (JP)

(21) Appl. No.: 15/542,180

(22) PCT Filed: Jan. 8, 2016
(86) PCT No.: PCT/JP2016/050541

§ 371 Date: Jul. 7, 2017

(30) Foreign Application Priority Data
Jan. 9, 2015 (JP) 2015-003549

(51) Int. Cl. G09G 3/36; G09G 3/34

(52) U.S. Cl. CPC G09G 3/3607; G09G 3/342; G09G 2320/062; G09G 2320/0242; G09G 2320/0276

(57) ABSTRACT

Coloration changes on a liquid crystal display device are mitigated in a low gray level region. Gray level data for a first pixel indicates a first gray level, n pieces of gray level data for the first to n-th pixels indicate a saturation index for the first pixel that has a first index value, and the first pixel exhibits an optical transmittance that is equal to a first optical transmittance. Alternatively, gray level data for a first pixel indicates a first gray level, n pieces of gray level data for the first to n-th pixels indicate a saturation index for the first pixel that has a second index value, and the first pixel exhibits an optical transmittance that is equal to a second optical transmittance. The first index value is smaller than the second index value, and the first optical transmittance is greater than the second optical transmittance.

### TECHNICAL FIELD

The present invention relates to liquid crystal display devices.

### BACKGROUND ART

Portion (a) of FIG. 10 is a graph representing a relationship between gray level data (gray levels 0 to 255) and chromaticity of a single picture element in a liquid crystal panel. The picture element is composed of a red pixel, a green pixel, and a blue pixel all of which are driven according to the same gray level data after the data is subjected to the same gamma correction. The curve x is a plot of chromaticity taken along the x coordinate of the chromaticity diagram in (b) of FIG. 10 whilst the curve y is a plot of chromaticity taken along the y coordinate of the chromaticity diagram in (b) of FIG. 10.

Portion (a) of FIG. 10 shows that both the x and y values in the xy chromaticity coordinates decrease with a decrease from gray level 255 (white) to gray level 80 and also that the x value abruptly increases with a change of the picture element display from gray level 40 to gray level 0 whereas the y value abruptly decreases with the same change. In other words, when an achromatic color is displayed, the coloration increasingly takes on a blue hue (so-called blue shift) as the picture element display changes from white (gray level 255) to light gray to medium gray. in stark contrast with this, with a change from dark gray to black, the coloration abruptly takes on a magenta hue. These changes in coloration of a display of achromatic and near colors (low saturation colors) are attributable to the wavelength dependence of the birefringence index of the liquid crystal and to the polarization properties of the liquid crystal.

### CITATION LIST

### Patent Literature

Patent Literature 1: Japanese Unexamined Patent Application Publication, Tokukai, No. 2013-238656

### SUMMARY OF INVENTION

### Technical Problem

Coloration changes in the high gray level region that occur in a display of an achromatic color and a low saturation color (blue shift) can be mitigated as shown in FIG. 11 by, for example, performing an independent gamma correction for the red, green, and blue pixels that make up the single picture element on the basis of a white display. However, coloration changes are hardly mitigated in the low gray level region in a display of an achromatic color and a low saturation color. Portions (a) and (b) of FIG. 12, (c) of FIG. 12, (a) of FIG. 13, (b) of FIG. 13, (a) and (b) of FIG. 14, (c) of FIG. 14, (a) of FIG. 15, and (b) of FIG. 15 show measurements on the liquid crystal panel under different conditions such as gap, temperature, and drive voltage. Each graph shows intense changes in the low gray level region that are uncontrollable. In (b) of FIG. 12, the x and y coordinates in (a) of FIG. 12 are plotted on a chromaticity diagram. In (b) of FIG. 14, the x and y coordinates in (a) of FIG. 14 are plotted on a chromaticity diagram.

This problem is more evident when priority is given to contrast (the ratio of the luminance of a white display picture element and the luminance of a black display picture element) in order to guarantee a display dynamic range of a liquid crystal display device. Improvement of contrast in liquid crystal display devices has been regarded as an important factor in competing with CRT-, PDP-, or OLED-based display devices. In local dimming technology (luminance control in segmental areas of a backlight) as described in Patent Literature 1 the low gray level region, where coloration is difficult to control, is actively utilized, As a result, coloration changes in the low gray level region pose an increasingly serious problem as contrast is improved.

One of the objects of the present invention is to mitigate coloration changes m the low gray level region in a display of an achromatic color and a to saturation color.

### Solution to Problem

The present intention is directed to a liquid crystal display device including picture elements each composed of first to n-th pixels, a portion of a liquid crystal layer in each pixel being rendered to exhibit an optical transmittance that is in accordance with gray level data, herein both: a case where gray level data for the first pixel indicates a first gray level, it pieces of gray level data fir the first to n-th pixels indicate a saturation index for the first pixel that has a first index value, and the first pixel exhibits an optical transmittance that is equal to a first optical transmittance; and a case where gray level data for the first pixel indicates a first gray level, n pieces of gray level data for the first to n-th pixels indicate a saturation index for the first pixel that has a second index value, and the first pixel exhibits an optical transmittance that is equal to a second optical transmittance are possible, the first gray level is included in a low gray level region that is a first half of all gray levels that can be indicated by the gray level data, and the first index value is smaller than the second index value, and the first optical transmittance is greater than the second optical transmittance.

Advantageous Effects of Invention

In the liquid crystal display device in accordance with the present invention, the optical transmittance of the first pixel is changed in accordance with the saturation index for the first pixel when the gray level data for the first pixel indicates the first gray level in the low gray level region e.g., near a minimum gray level). ln this manner, the optical transmittance in the low gray level region is rendered higher in a low saturation display than in a high saturation display. This configuration mitigates coloration changes in the low gray level region in a low saturation display and also can ensure contrast M a high saturation display.

### BRIEF DESCRIPTION OF DRAWINGS

FIG. 1 is a block diagram of a structure of the present liquid crystal display device.

FIG. 2 is a function diagram representing functions of a processor in a display control circuit in Embodiment 1.

FIG. 3 shows graphs representing gray level conversion characteristics of a first LUT (for red pixels) and a second LUT for red pixels) both provided in the display control circuit shown in FIG. 1.

FIG. 4 is a calculation content diagram describing how calculations are made in S2b and S2c in FIG. 2,

FIG. 5 is a drawing showing results of calculations made in FIG. 4.

FIG. 6 shows graphs representing a relationship between the input gray level and optical transmittance of the present liquid crystal display device (one graph for zero saturation and another for full saturation).

FIG. 7 is a calculation content diagram describing how saturation indices are calculated in Embodiment 2.

FIG. 8 is a calculation content diagram describing how saturation indices are calculated in Embodiment 2.

FIG. 9 is a function diagram representing functions of a processor in a display control circuit in Embodiment 3.

Portion (a) of FIG. 10 is a graph representing display characteristics of a conventional liquid crystal display device whilst (b) of FIG. 10 is a chromaticity diagram for the conventional liquid crystal display device.

FIG. 11 is a graph representing display characteristics of the liquid crystal display device shown in (a) of FIG. 10 after an independent gamma correction in the liquid crystal display device.

Portions (a) to (c) of FIG. 12 are graphs representing display characteristics of a conventional liquid crystal display device.

Portions (a) and (b) of FIG. 13 are graphs representing display characteristics of a conventional liquid crystal display device,

Portions (a) to (c) of FIG. 14 are graphs representing display characteristics of a conventional liquid crystal display device.

Portions (a) and (b) of FIG. 15 are graphs representing display characteristics of a conventional liquid crystal display device.

### DESCRIPTION OF EMBODIMENTS

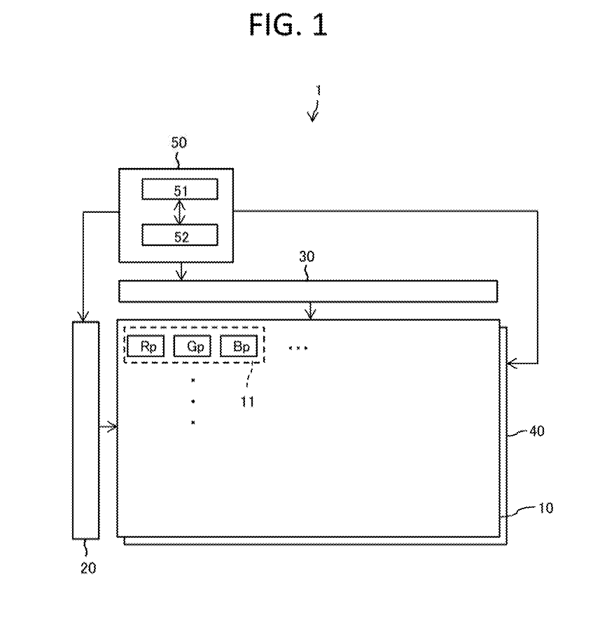

FIG. 1 is a block diagram of a structure of the present liquid crystal display device, As shown in FIG. 1, the present liquid crystal display device 1 includes a liquid crystal panel 10, a gate driver 20 and a source driver 30 that drive the liquid crystal panel 10, a backlight 40 that shines light onto the liquid crystal panel 10, and a display control circuit 50 that controls the gate and source drivers 20 and 30 and the backlight 40. The backlight 40 allows for individual control of the luminance of emission light for each segmental area of the liquid crystal panel 10 in accordance with the brightness of video to be displayed in that segmental area (“local dimming”).

The liquid crystal panel is preferably a so-called “birefringence mode” liquid crystal panel having a liquid crystal layer interposed between two transparent substrates, in which liquid crystal molecules change orientation thereof under voltage applied by the source driver 30 to vary optical transmittance by means of polarizer plates disposed on top and bottom. Examples of such liquid crystal panels include the TN liquid crystal panel, the VA liquid crystal panel, and the IPS liquid crystal panel.

The liquid crystal panel 10 includes a plurality of picture elements 11 arranged, for example, in a matrix. Each picture element 11 is composed of a red pixel Rp, a green pixel Gp, and a blue pixel Bp. The display control circuit 50 includes a processor 51 and a memory 52.

### Embodiment 1

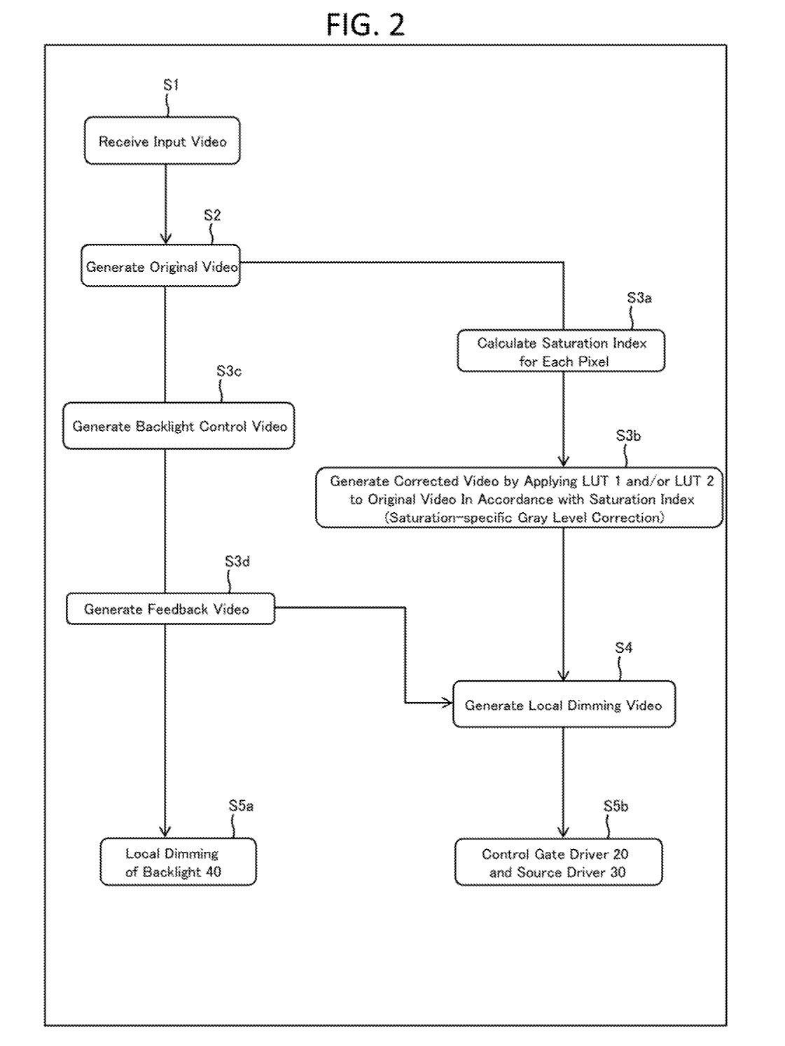

FIG. 2 is a function diagram representing functions of the processor 51 shown in FIG. 1 in accordance with Embodiment 1. As shown in FIG. 2, the processor 51 receives input video in step S1 so as to generate original video by subjecting the input video to degamma and color correction, edge processing, and/or other video processing (step S2).

Next, the processor 51 calculates a saturation index for each pixel (step S3a), retrieves a LUT 1 (lookup table 1) for use in low saturation (“low saturation. LUT 1”) and a LUT 2 (lookup table 2) for use in high saturation (“high saturation LUT 2”) from the memory 52, and applies the LUT 1 and/or LUT 2 to the original video in accordance with the saturation indices (saturation-specific gray level correction), to generate corrected video (step S3b).

The processor 51 then generates, in accordance with the brightness of the video to be displayed in each segmental area of the liquid crystal panel 10, video for use in backlight control (“backlight control video”) that has a lower resolution than the original video (step S3c). The processor 51 further generates video for use in feedback (“feedback video”) based on the backlight control video and characteristics of the backlight 40 (step S3d).

Next, the processor 51 adjusts gray levels in accordance with specific local dimming (luminance of each segmental area of the backlight 40) and characteristics of the liquid crystal panel 10 based on the corrected video generated in step S3b and the feedback video generated in step S3d, to generate video for use in local dimming (“local dimming video”) (step S4).

The processor 51 then performs local dimming on die backlight 40 based on the backlight control video generated in step S3c (step 5a) and also controls the gate driver 20 and the source driver 30 based on the local dimming video generated in step S4 (step S5b).

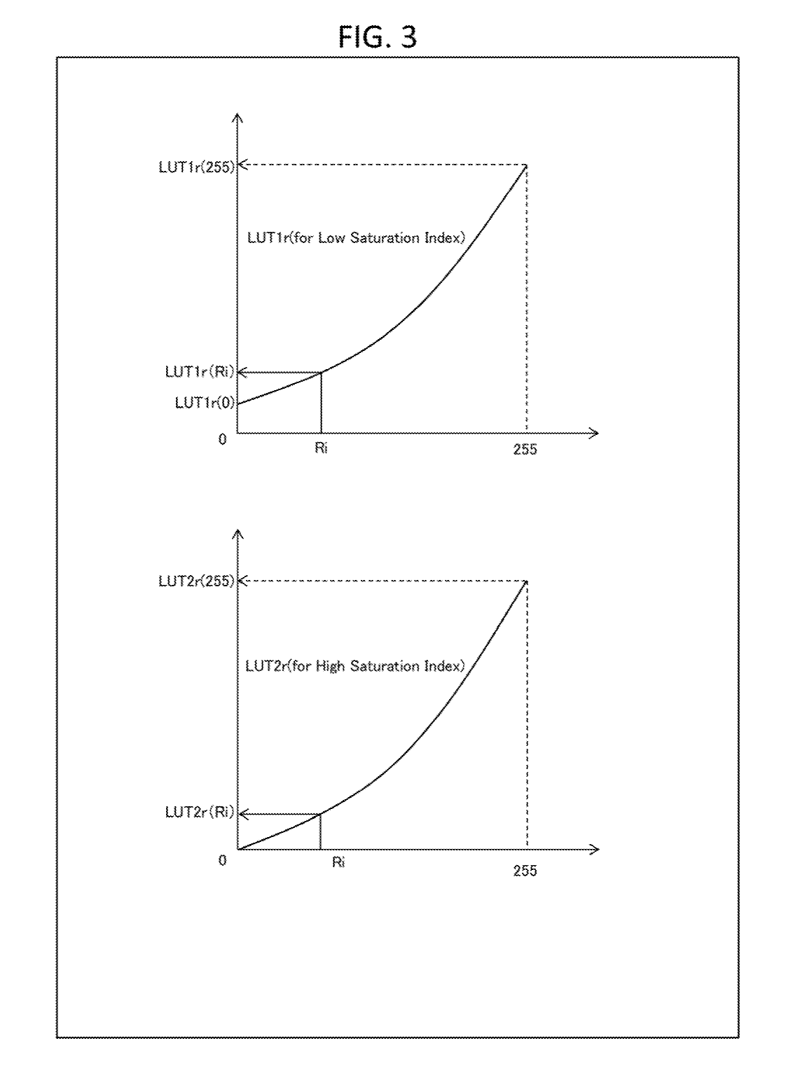

The memory 52 stores a combination of a red pixel LUT 1r, a green pixel LUT 1g, and a blue pixel LUT 1b that is prepared in advance as the low saturation LUT 1 and a combination of a red pixel LUT 2r, a green pixel LUT 2g, and a blue pixel LUT 2b that is prepared in advance as the high saturation LUT 2. For example, the low saturation LUT 1r (first gray level correction table) has an input range of gray levels 0 to 255 and an output range of LUT 1r (0) to LUT 1r (255) as shown in FIG. 3. The high saturation LUT 2r (second gray level correction table) has an input range of gray levels 0 to 255 and an output range of LUT 2r (0) to LUT 2r (255). Note that LUT 1r (0)>LUT 2r (0) gray level 0 and also that the LUT 1r has a smaller output dynamic range than the LUT 2r. This difference corresponds to that part which corresponds to the input of from gray level 0 to the threshold gray level (e.g., gray level 321 to the LUT 2r, The relationship between the green pixel LUTs 1g and 2g and the relationship between the blue pixel LUTs 1b and 2b, although none of them shown, are the same as the relationship between the red pixel LUTs 1r and 2r.

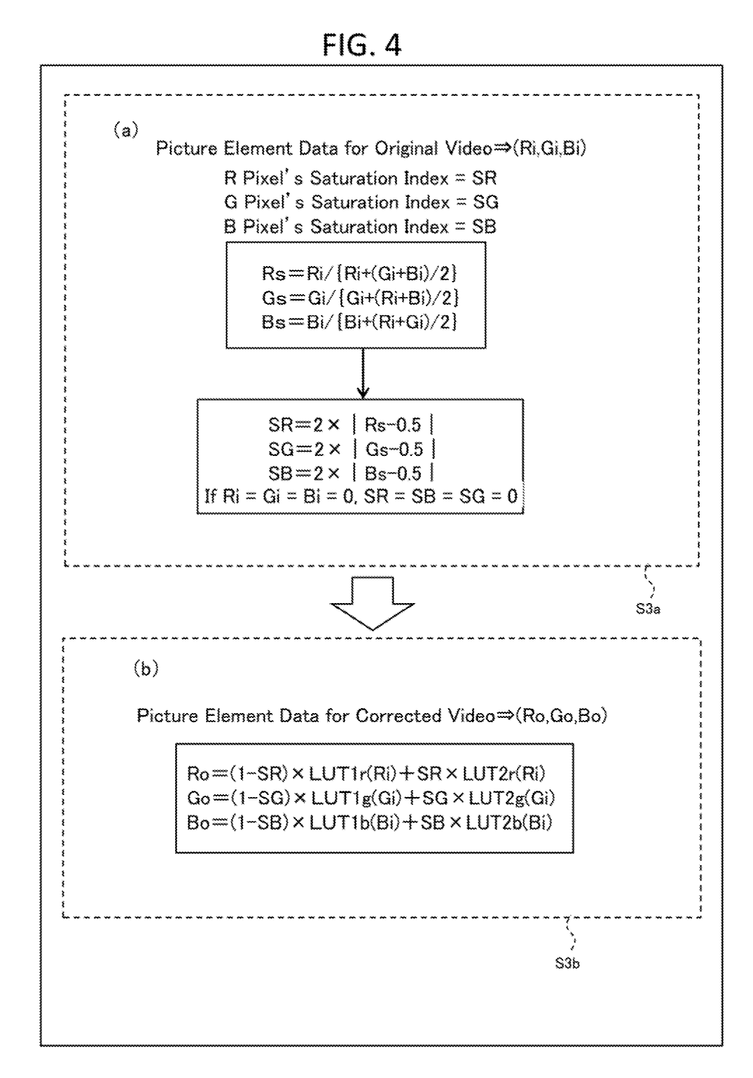

Step S3a is executed, for example, as shown in (a) of FIG. 4 on the original video's picture element data (gray level data for the red pixel Rp, the green pixel Gp, and the blue pixel Bp constituting the picture element 11) that is Ri (gray levels 0 to 255), Gi (Gray levels 0 to 255), and Bi (gray levels 0 to 255).

More specifically, taking Rs=Ri/{Ri+(Gi+Bi)/2}, Gs=Gi/{Gi+(Ri+Bi)/2}, and Bs=Bi/{Bi+(Ri+Gi)/2}, the red pixel saturation index SR is given by SR=2×|Rs−0.5|, the green pixel saturation index SG by SG=2×|Gs−0.5|, and the blue pixel saturation index SB by SB=2×|Bs−0.5|. These calculations indicate that if Ri=Gi=Bi=0, SR=SG=SB=0, that if Ri=255 and Gi=Bi=0, SR=1, and also that if Ri=0 and Gi=Bi=255, again SR=1. It follows that the saturation indices increase when there is a large difference between the gray levels of the pixels in the picture element.

In step S3b, a saturation-specific gray level correction is performed, for example, as shown in (b) of FIG. 4 on the corrected video's picture element data is Ro, Go, and Bo.

That is, Ro=(1−SR)×LUT 1r(Ri)+SR×LUT 2r (Ri), Go=(1−SG)×LUT 1g (Gi) +SG×LUT 2g (Gi), and Bo=(1−SB)×LUT 1b (Bi)+SB×LUT 2b (Bi).

Each saturation index S may be subjected to a correction such as the one represented by the equation, S=Gain×(S−0.5)+0.5 (if the value is less than 0 and if the value is in excess of 1, the value is clipped to 0 and 1 respectively), to adjust the region to which the LUT 1 and the LUT 2 should be applied.

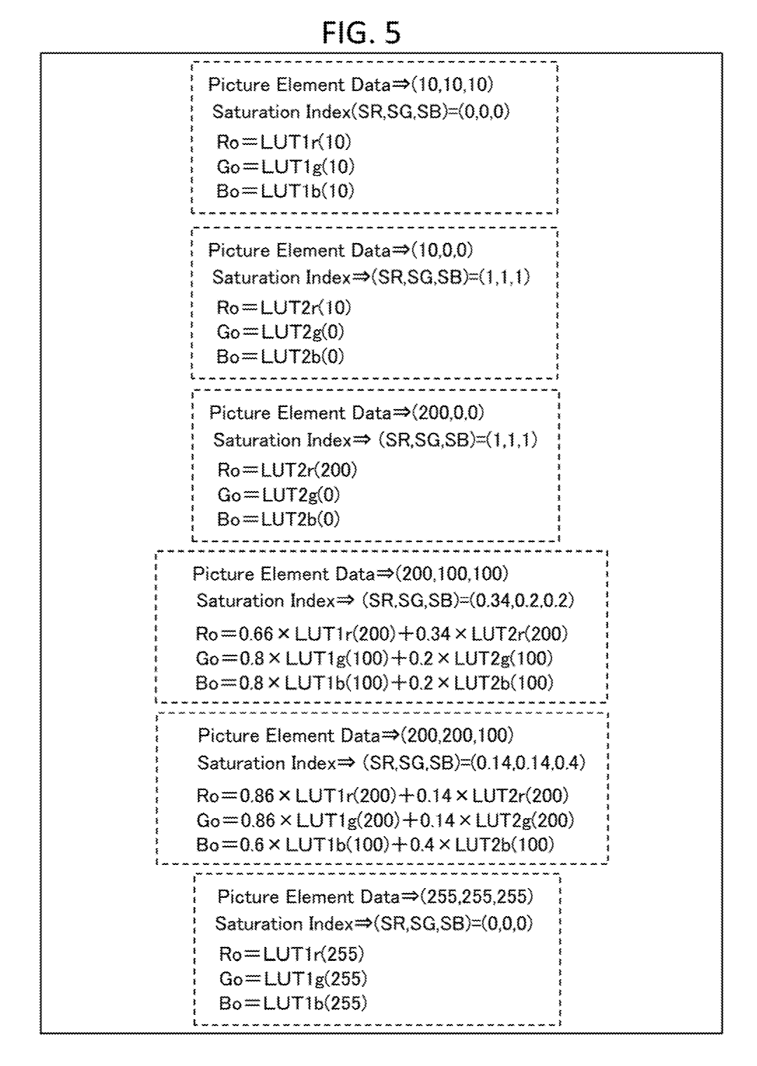

As a result of the correction, if the picture element data (red pixel gray level data, green pixel gray level data, blue pixel gray level data) is (10, 10, 10), it follows that the saturation indices (SR, SG, SB) are (0, 0, 0) and also that Ro=LUT 1r (10), Go=LUT 1g (10), and Bo=LUT 1b (10), as shown in FIG. 5.

If the picture element data is (10, 0, 0), the saturation indices (SR, SG, SB) are (1, 1, 1), and Ro=LUT 2r (10), Go=LUT 2g (0), and Bo=LUT 2b (0).

If the picture element data is (200, 0, 0), the saturation indices (SR, SG, SB) are (1, 1, 1), and Ro=LUT 2r (200), Go=LUT 2g (0), and Bo−LUT 2b (0)

If the picture element data is (200, 100, 100), the saturation indices (SR, SG, SB) are (0.34, 0.2, 0.2), and Ro=0.66×LUT 1r (200)+0.34×LUT 2r (200), Go=0.8×LUT 1g (100)+0.2×LUT 2g (100), and Bo=0.8×LUT 1b (100)+0.2×LUT 2b (100).

If the picture element data is (200, 200, 100), the saturation indices (SR, SG, SB) are (0.14, 0.14, 0.4), and Ro=0.86×LUT 1r (200)+0.14×LUT 2r (200), Go0.86×LUT 1g (200)+0.14×LUT 2g (200), and Bo=0.6×LUT 1b (100)+0.4×LUT 2b (100).

If the picture element data is (255, 255, 255), the saturation indices (SR, SG, SB) are (0, 0, 0), and Ro=LUT 1r (255), Go=LUT 1g (255), and Bo=LUT 1b (255).

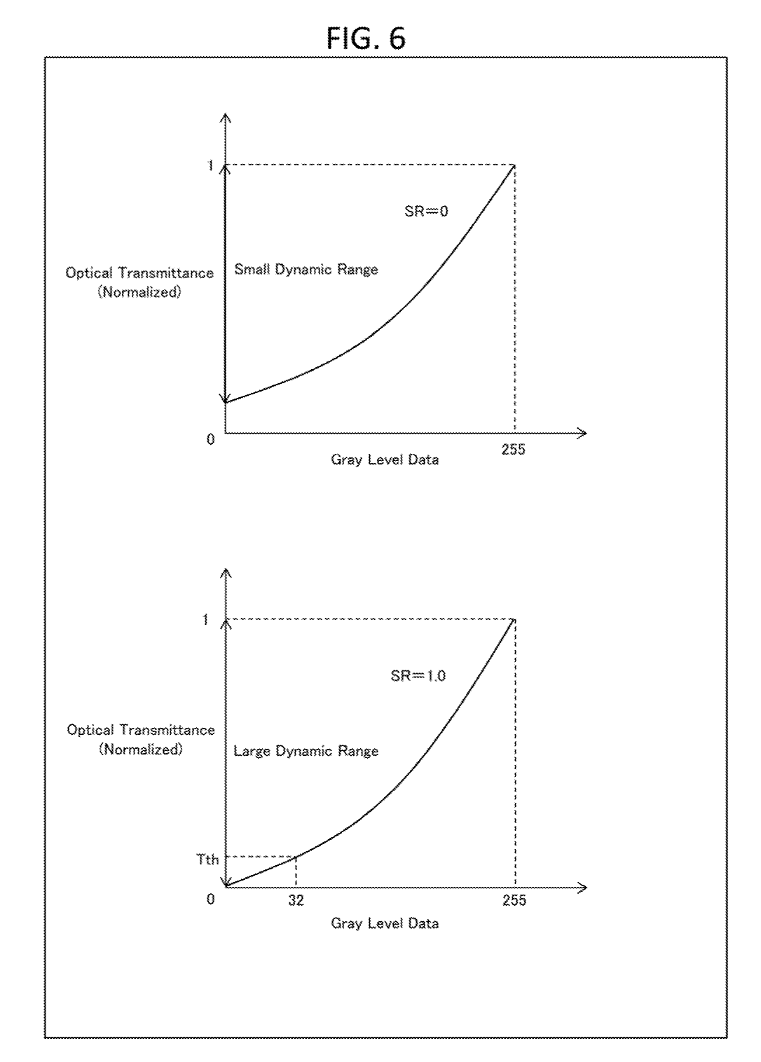

From these results, the dynamic range of the optical transmittance of the red pixel Rp is smaller, for example, when the gray level data for the red pixel Rp is changed from 0 to 255 with the saturation index SR for the red pixel Rp being fixed to, for example, 0 (minimum) than when the gray level data for the red pixel Rp is changed from 0 to 255 with the saturation index SR for the red pixel Rp being fixed to, for example, 1.0 (maximum), as shown in FIG. 6.

The difference in dynamic range of the optical transmittance between when SR=0 and when SR=1.0 corresponds to that part which corresponds to gray level 0 to gray level 32 (threshold gray level) of the gray level data when SR=1.0.

The optical transmittance Tth corresponding to this threshold gray level is preferably less than or equal to 0.01 (less than or equal to 1% of the optical transmittance corresponding to gray level 255) and more preferably greater than or equal to 0.001 and less than or equal to 0.01 (greater than or equal to 0.1% and less than or equal to 1% of the optical transmittance corresponding to gray level 255, i.e., approximately to gray levels 12 to 32).

It should be noted here that because, for example, the optical transmittance of the red pixel Rp is set via a signal voltage inputted to the red pixel Rp, the dynamic range of the signal voltage inputted to the red pixel Rp is smaller when the gray level data for the red pixel Rp is changed from 0 to 255 with the saturation index SR for the red pixel Rp being fixed to 0 than when the gray level data for the red pixel Rp is changed from 0 to 255with the saturation index SR for the red pixel Rp being fixed to 1.0.

In addition, the dynamic range of the signal voltage inputted to the red pixel Rp is greater when the gray level data for the red pixel Rp is changed from 0 to 255 with the gray level data for the green and blue pixels being fixed to a maximum (gray level 255) than when the gray level data for the red pixel Rp is changed from a minimum (gray level 0) to the maximum with the gray level data for the green and blue pixels being fixed to the minimum,

The difference in dynamic range of the signal voltage between when SR=0 and when SR=1.0 corresponds to that part which corresponds to gray levels 0 to 32 of the gray level data when SR=1.0.

In the liquid crystal display device 1, the optical transmittance of each pixel is changed in accordance with the saturation index for the pixel when the gray level data for the pixel is in the low gray level region (e.g., near the minimum gray level). In other words, the optical transmittance in the low gray level region is rendered higher in a low saturation display than in a high saturation display. This configuration mitigates coloration changes in the low gray level region in a low saturation display and also can ensure contrast in a high saturation display.

Although the dynamic range of the optical transmittance is relatively small in a low saturation display, a contrast of approximately 500 can be guaranteed, which would be an adequate display characteristic for bright video, in the case shown in FIG. 6, assuming that the inherent contrast of the liquid crystal panel is 2000. On the other hand, low contrast becomes apparent on a dark screen. This issue is addressed by lowering the luminance of emission light from the backlight 40 to ¼ to ⅛ by local dimming, thereby achieving a total contrast of 2000 to 4000.

This mechanism works effectively if the liquid crystal panel 10 operates in birefringence mode and particularly so if the liquid crystal panel 10 operates in a mode that exploits tilt angles (e.g., TN and VA modes). The mechanism also enables more effective use of the inherent dynamic range of the optical transmittance of the liquid crystal panel even in liquid crystal modes that do riot exploit tilt angles (e.g., IPS mode).

### Embodiment 2

In (a) of FIG. 4, it is specified as an example that SR=f×|Rs−0.5| and f=2, which is by no means meant to be the only possibility if high saturation video looks unnatural as a result of an excessively enhanced dynamic range, f may be set to approximately 1 to 1.5 so that not the entire dynamic range is used, which produces visible results. Using up a greater part of the dynamic range by setting f conversely to as high as 2 or even higher and clipping f to 1 when SR≥1 is of course similarly effective in liquid crystal panels in which coloration changes on the low gray level end are less of a problem,

In addition, in (a) of FIG. 4, it is taken that SR=2×|Rs−0.5| where Rs=Ri/{Ri+(Gi +Bi)/2} as an example, which is by no means meant to be the only possibility. Alternatively, Rs and SR may be determined by the formulae: SR=3×|Rs−1/3|where Rs=Ri/(Ri+Gi+Bi).

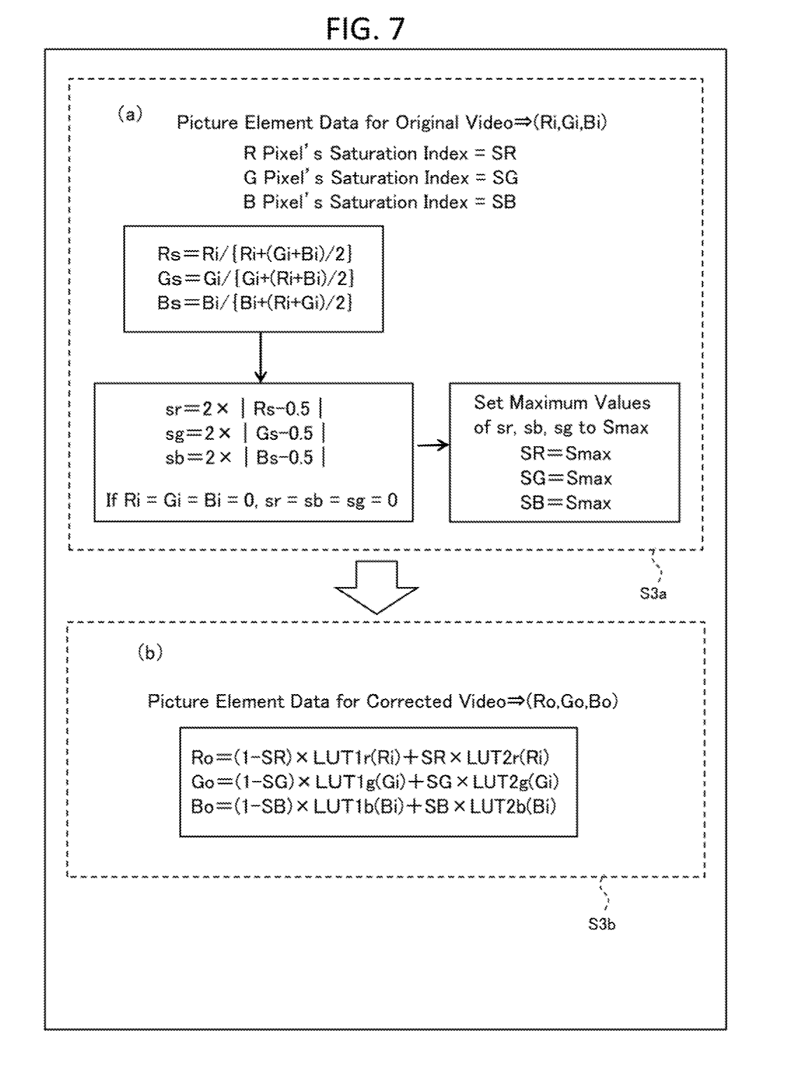

The saturation indices (SR, SG SB) may be determined as shown in FIG. 7. More specifically, the picture element data (gray level data for the red pixel Rp, the green pixel Gp, and the blue pixel Bp) of the original video is Ri (gray levels 0 to 255), (ii (gray levels 0 to 255, and Bi (gray levels 0 to 255) respectively. Furthermore, Rs=Ri/{Ri+(Gi+Bi)/2}, Gs=Gi/{Gi+Bi)/2}, Bs=Bi/{Bi+Gi)/2}, sr=2×|Rs−0.5|, sg=2×|Gs−0.5|, and sb=2×|Bs−0.5|. Additionally, the maximum values of sr, sg, and sb are equal to smax, and SR=SG=SB=Smax. When this is actually the case, the picture element data (Ro, Go, Bo) of the corrected video is determined likewise by the formulae: Ro=(1=SR)×LUT 1r(Ri)+SR×LUT 2r (Ri), Go=(1−SG)×LUT 1g (Gi)+SG×LUT 2g (Gi), and Bo=(1−SB)×LUT 1b (Bi)+SB×LUT 2b (Bi).

The technique represented in FIG. 7 is convenient when the dynamic range is to be broadened to ignore minor colors in video with a high saturation index and is preferable when the backlight 40 emits white light. When the fight exiting the backlight 40 is produced by light sources of complementary colors such as blue and yellow, green and magenta, or red and cyan, it is also preferable to calculate the saturation indices in accordance with a color group and employ one of the grouped colors that has a greater saturation index.

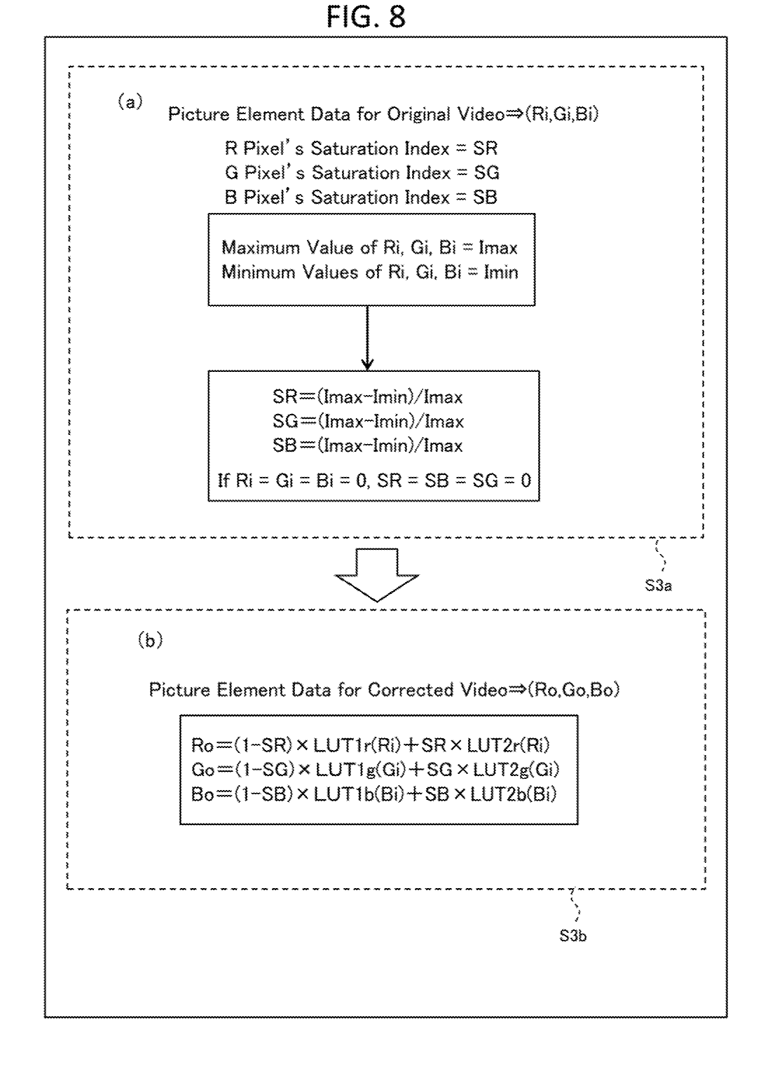

As a further alternative, the saturation indices (SR, SG, SB) may be determined as shown in FIG. 8. More specifically, the picture element data of the original video is Ri (gray levels 0 to 255), Gi (gray levels 0 to 255), and Bi (gray levels 0 to 255) respectively. The maximum values of Ri, Gi, and Bi are Imax, the minimum values of Ri, Gi, and Bi are Imin, and SR=SG=SB=(Imax−Imin)/Imax (if Ri=Gi=Bi=0, SR=SB=SG=0). When this is actually the case, the picture element data (Re, Go, Bo) of the corrected video is determined likewise by the formulae: Ro=(1−SR)×LUT 1r (Ri)+SR×LUT 2r (Ri), Go=(1−SG)×LUT 1g (Gi)+SG×LUT 2g (Gi), and Bo=(1−SB)×LUT 1b (Bi)+SB×LUT 2b (Bi).

The saturation indices used here are equivalent to the calculation of saturation in HSV space that is frequently used in general image processing. If the liquid crystal display device is used not as a television, but as a PC monitor, individual users often perform image processing in HSV space. More natural looking displays become possible by incorporating a process that corresponds one-to-one to the saturation used by the user.

### Embodiment 3

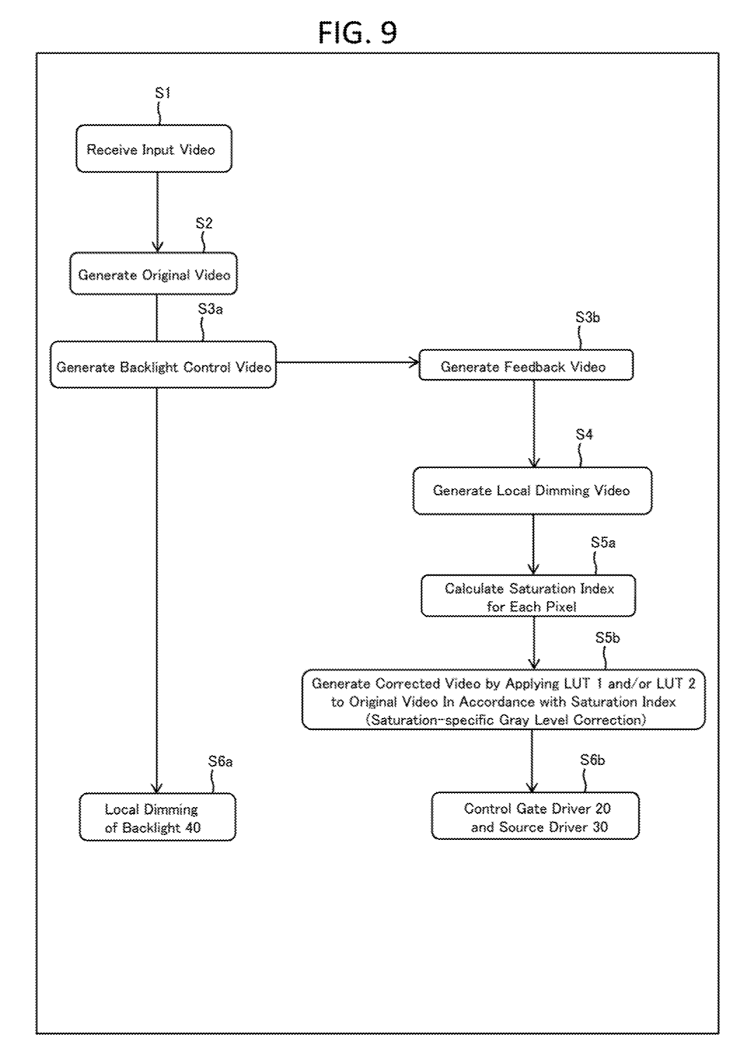

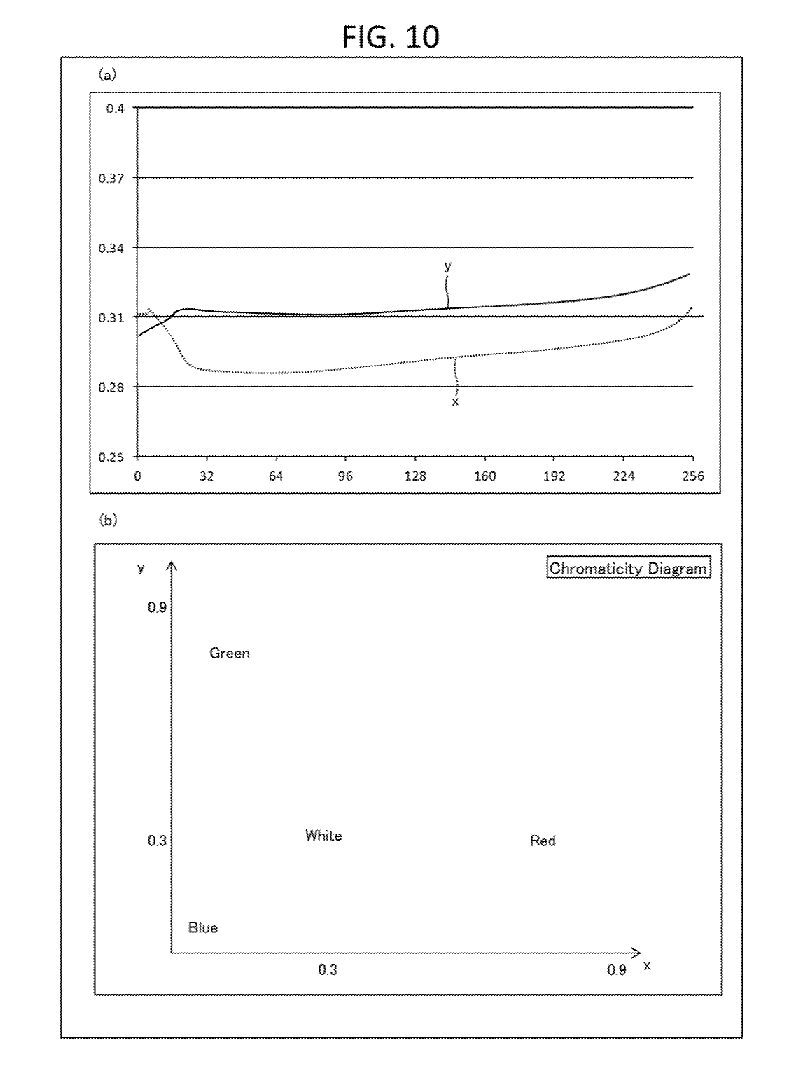

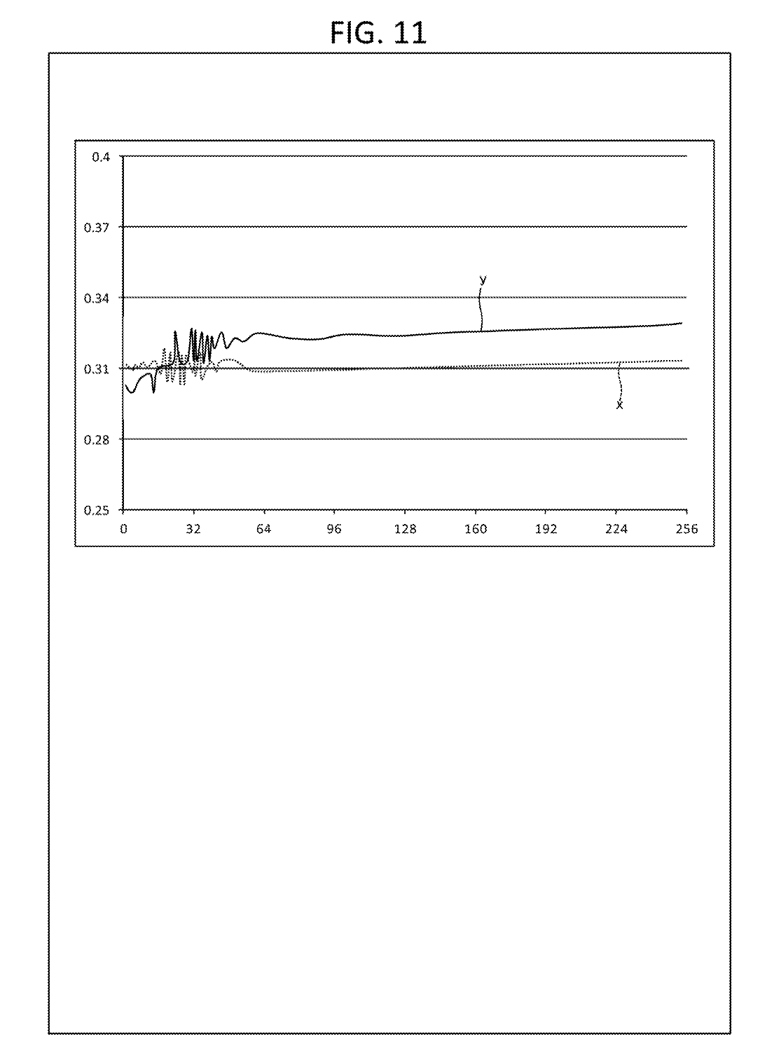

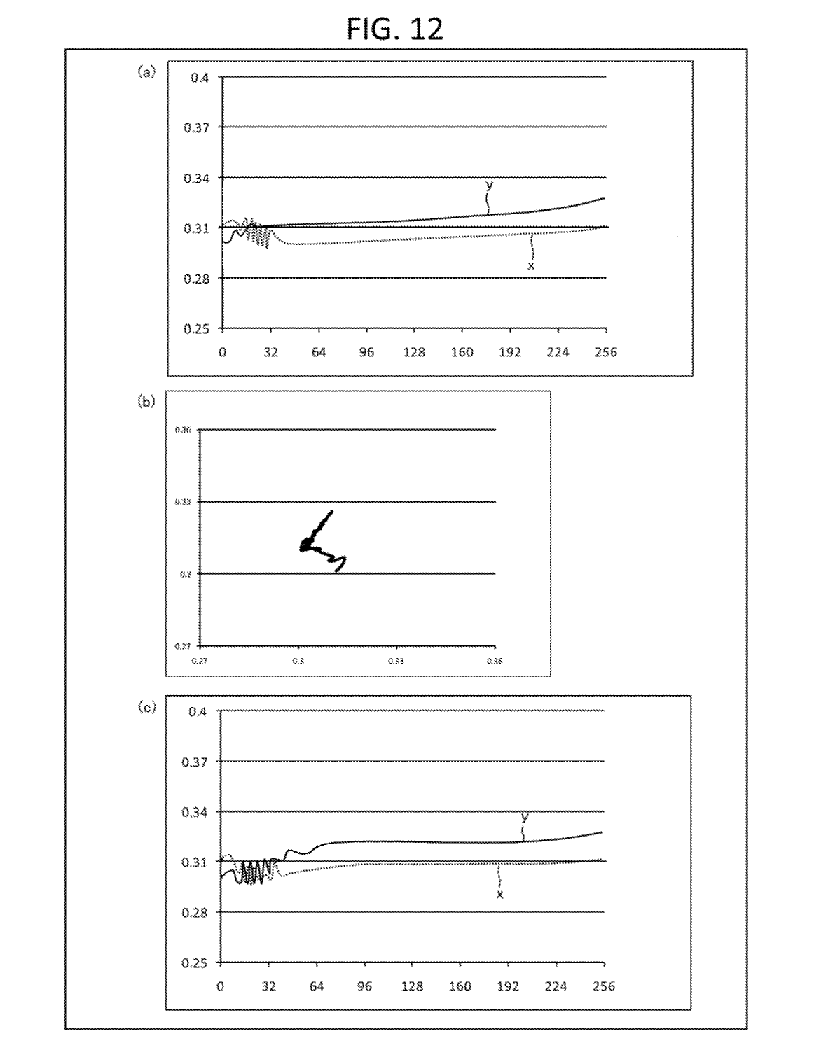

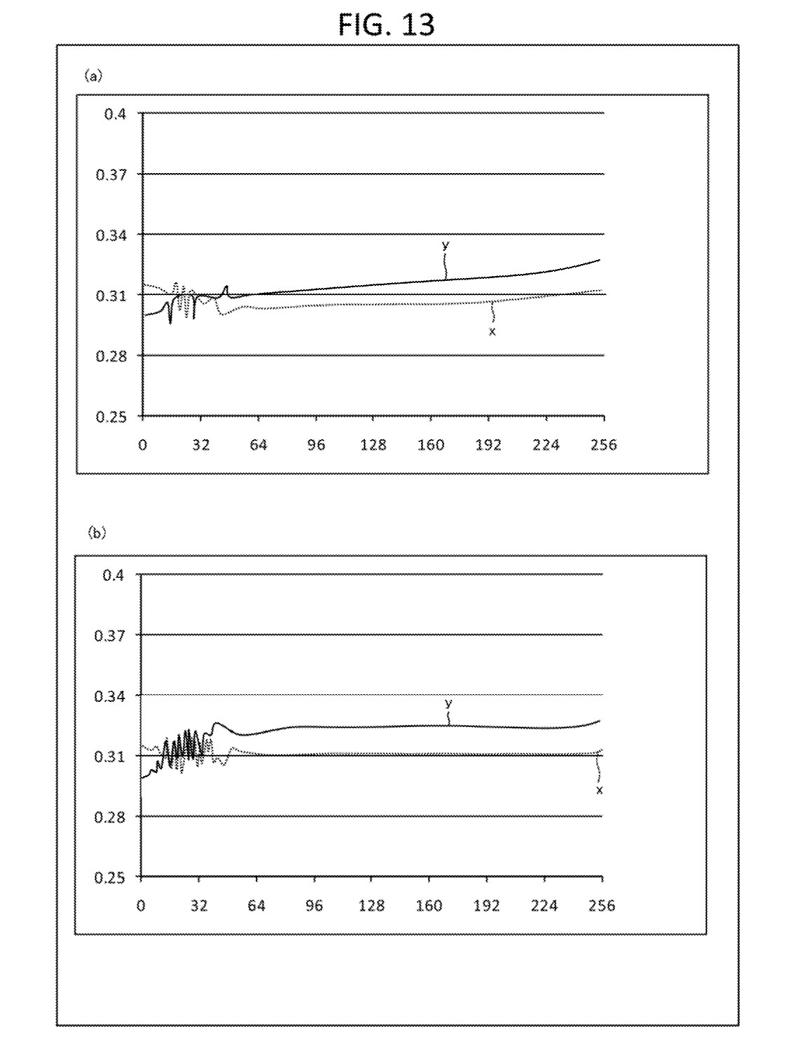

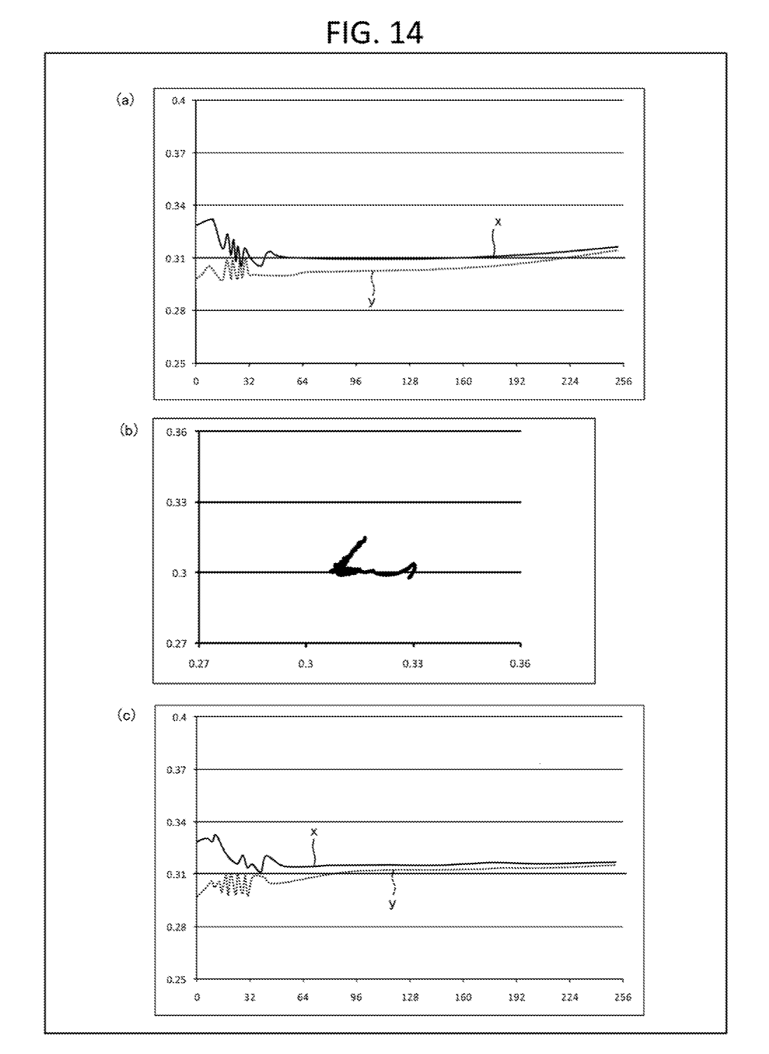

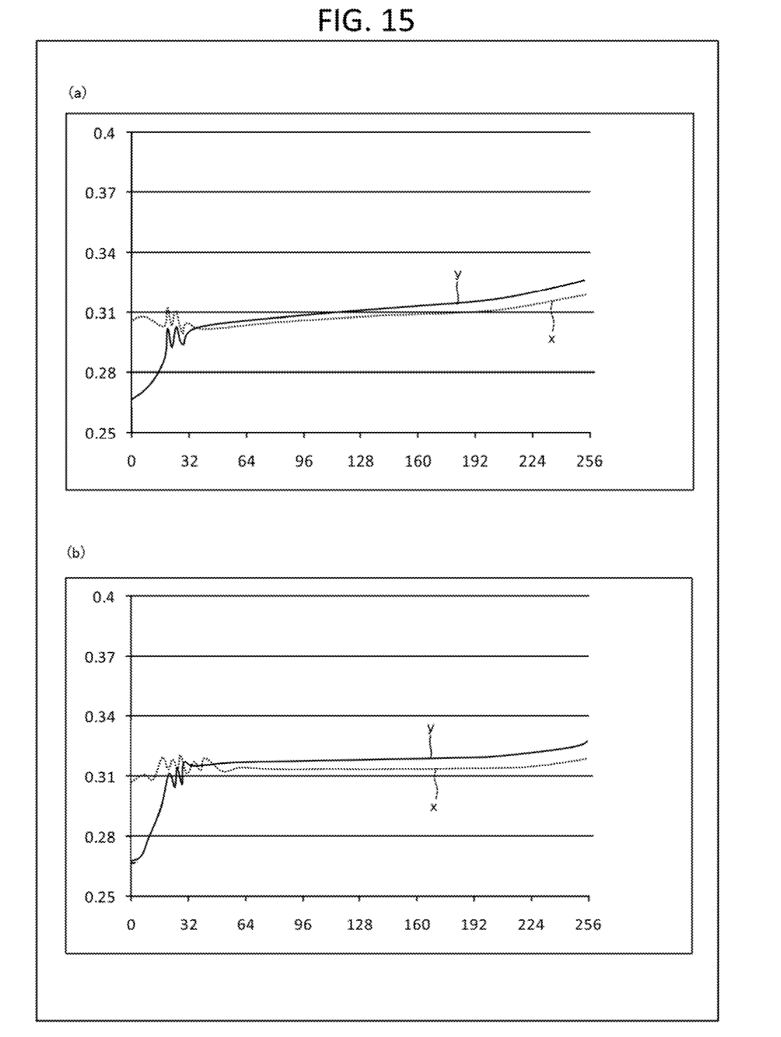

FIG. 9 is a function diagram representing functions of a processor 51 shown in FIG. 1 in accordance with Embodiment 3. As shown in FIG. 9, the processor 51 receives input video in step S1, so as to generate original video by subjecting the input video to degamma and color correction, edge processing, and/or other video processing (step S2).

Next, the processor 51 generates, in accordance with the brightness of the video to be displayed in each segmental area of the liquid crystal panel 10, backlight control video that has a lower resolution than the original video (step S3a). The processor 51 then generates feedback video based on the backlight control video and characteristics of the backlight 40 (step S3b).

Next, the processor 51 adjusts gray levels in accordance with specific local dimming (luminance of each segmental, area of the backlight 40) and characteristics of the liquid crystal panel 10 based on the feedback video generated in step S3b, to generate local dimming video (step S4).

Next, the processor 51 calculates a saturation index for each pixel for the local dimming video generated in step S4 (step S5a), retrieves a low saturation LUT 1 (lookup table 1) and a high saturation LUT 2 (lookup table 2) from the memory 52, and applies the LUT 1. and/or LUT 2 to the local dimming video in accordance with the saturation indices (saturation-specific gray level correction), to generate corrected video (step S5b).

The processor 51 then performs local dimming on the backlight 40 based on the backlight control video generated in step S3a (step 6a) and also controls the gate driver 20 and the source driver 30 based on the corrected video generated in step S5b (step S6b).

Since a saturation-specific gray level correction is performed on the local dimming video as described above, the LUT 1 and LUT 2 are applied taking the video brightness into consideration. This configuration can more effectively achieve both suppressed coloration change in low saturation video and sufficient contrast in high saturation video. The saturation-specific gray level correction represented in FIG. 9 is particularly effective, for example, when the dynamic range is to be broadened by a large ratio and when the backlight 40 has a high spatial resolution, because under these conditions the video outputted to the liquid crystal panel differs significantly from the original video.

### Further Description of Embodiments Presented Above

In Embodiments 1 to 3, each picture element is composed of 3 (red, green, and blue) pixels. This is by no means meant to be the only possible structure. Alternatively, each picture element may be composed of 4 (red, green, blue, and yellow; red, green, blue, and white; or red, green, blue, cyan) pixels, 5 (red, green, blue, yellow, and cyan; or red, green, blue, yellow, and white) pixels, 6 (red green, blue, yellow, cyan, and magenta; or red, green, blue, yellow, cyan, and white) pixels, or 7 (red, green, blue, yellow, cyan, magenta, and white) pixels. The more pixels each picture element is composed of, the greater display color range the display device can provide, and the more efficiently light can be used.

Each additional pixel, however, unfailingly requires calculation of another saturation index. More pixels need to be compared, and more pixels need to be evaluated, which exponentially increases the amount of calculation. In addition, color representation becomes increasingly redundant, which may adversely affect logical support for the calculation.

More specifically, if the common components of RGB are used as W in a device with RGBW pixels, the lowest one of the saturation indices for the RGB pixels is increased significantly. Consequently, low saturation video may be subjected to a process designed for high saturation, and unnatural looking images could be generated in some operating environments

Accordingly, the input video may be grouped by common color components before evaluation of saturation indices in any of the embodiments.

For example, in a liquid crystal panel in which each picture element is composed of 4 (red R, green G, blue B, and white W) pixels, the W component contains all of RGB. Therefore, saturation indices are calculated based on input RGB information, and the largest value is applied across R, G, B, and W.

In a liquid crystal panel in which each picture element is composed of 4 (red R, green G, blue B, and yellow Y) pixels, Y contains R and G components (no B component). Therefore, saturation indices (SR, SG, SB) are calculated based on input RGB signals. SB is applied to B whereas SY, which is a larger, one of SR and SQ, is applied across R, G, and Y.

In the case of each picture element being composed of 4 (red R, green G blue B, and cyan C) pixels, saturation indices (SR, SG, SB) are likewise calculated based on input RGB signals. SR is applied to R whereas SC, which is a larger one of SG and SB, is applied across G, B, and C.

In Embodiments 1 to 3, it is difficult to choose a parameter that is uniquely determined for the same data if each picture element is composed of 5 or more pixels. In a panel in which each picture element is composed of 5 or more pixels, input ROB signal are decomposed into all pixel components for individual evaluation. In these cases, the present invention can also effectively use the dynamic range.

As described in the foregoing, each picture element in Embodiments 1 to 3 is composed preferably of 3 to 7 pixels and more preferably of 3 (RGB) or 4 (RGBW, WGBY, RGBC) pixels. These configurations can achieve both effective use of the dynamic range and stability in color reproduction.

In Embodiments 1 to 3, the optical transmittance of each pixel is adjusted in accordance with a saturation index. This saturation index does not indicate so-called color purity, but is an evaluation of how much different the optical transmittance of the pixel of interest is from those of the surrounding pixels (how much higher or lower).

The saturation index in Embodiments 1 to 3 differs from saturation as a psychological or sensory index, indicates a deviation of the transmission factor of a color based on white balance settings of the display device, and monotonically varies with saturation. Since the saturation index in Embodiments 1 to 3 is, a described above, intended to be used not to reproduce color saturation, but to design and use a dynamic range that is suited to saturation, any parameter may be employed that changes monotonically with saturation. A person who practices the present invention can choose an appropriate parameter in consideration of ease in implementing computation, user environment, and other factors.

In FIGS. 2 and 9, the inputted video signals are converted to an original image of multiple pixels by subjecting the signals to predetermined video processing and then decomposing (reconfiguring) the color components of the original image into color components fear the pixels of the liquid crystal panel (S2). A saturation index is then calculated for each one of these pixels, and the LUT 1 author LUT 2 is/are applied.

The present invention is directed to a liquid crystal display device including picture elements each composed of first to n-th pixels, a portion of a liquid crystal layer in each pixel being rendered to exhibit an optical transmittance that is in accordance with gray level data, wherein both: a case where gray level data for the first pixel indicates a first gray level, n pieces of gray level data for the first to n-th pixels indicate a saturation index for the first pixel that has a first index value, and the first pixel exhibits an optical transmittance that is equal to a first optical transmittance; and a case where gray level data for the first pixel indicates a first gray level, n pieces of gray level data for the first to n-th pixels indicate a saturation index for the first pixel that has a second index value, and the first pixel exhibits an optical transmittance that is equal to a second optical transmittance are possible, the first gray level is included in a low gray level region that is a first half of all gray levels that can be indicated by the gray level data, and the first index value is smaller than the second index value, and the first optical transmittance is greater than the second optical transmittance.

In another configuration of the liquid crystal display device in accordance with the present invention, the optical transmittance of the first pixel has a smaller dynamic range W hen (a) the gray level data for the first pixel is changed from a minimum to a maximum with the saturation index for the first pixel being fixed to the first index value than when (b) the gray level data for the first pixel is changed from the minimum to the maximum with the saturation index for the first pixel being fixed to the second index value.

In yet another configuration of the liquid crystal display device in accordance with the present invention, the optical transmittance of the first pixel is set via a signal voltage inputted to the first pixel, and the signal voltage inputted to the first pixel has a smaller dynamic range when (a) the gray level data for the first pixel is changed from a minimum to a maximum with the saturation index for the first pixel being fixed to the first index value than when (b) the gray level data for the first pixel is changed from the minimum to the maximum with the saturation index for the first pixel being fixed to the second index value.

In still another configuration of the liquid crystal display device in accordance with the present invention, the optical transmittance of the first pixel is set via a signal voltage inputted to the first pixel, and the signal voltage inputted to the first pixel has a greater dynamic range when the gray level data for the first pixel is changed from a minimum to a maximum with the gray level data for the second to n-th pixels being fixed to the maximum than when the gray level data for the first pixel is changed from the minimum to the maximum with the gray level data for the second to n-th pixels being fixed to the minimum.

In yet still another configuration of the liquid crystal display device in accordance with the present invention, the dynamic range has a difference between (a) and (b) that corresponds to a part that corresponds to from a minimum gray level to a threshold gray level of the gray level data in (b), and the threshold gray level is included in the low gray level region.

In a further configuration of the liquid crystal display device in accordance with the present invention, the threshold gray level is either equal to or lower than gray level 32 when the gray level data can indicate 256 gray levels.

In set a further configuration of the liquid crystal display device in accordance with the present invention, an optical transmittance that corresponds to the threshold gray level is less than or equal to 1% of an optical transmittance that corresponds to a maximum gray level.

In still a further configuration of the liquid crystal display device in accordance with the present invention, the optical transmittance that corresponds to the threshold gray level is greater than or equal to 0.1% and less than or equal to 1% of the optical transmittance that corresponds to the maximum gray level.

In yet still a further configuration of the liquid crystal display device in accordance with the present invention, the saturation index for the first pixel is determined using a relationship between the n pieces of gray level data for the first to n-th pixels and the gray level data for the first pixel.

In an additional configuration of the liquid crystal display device in accordance with the present invention, the saturation index for the first pixel is determined using a relationship between a maximum value and a minimum value indicated by the n pieces of gray level data for the first to n-th pixels,

Another configuration of the liquid crystal display device in accordance with the present invention further includes a backlight that shines light onto a liquid crystal panel divided into a plurality of segmental areas, wherein the backlight is controlled so as to illuminate each individual segmental area with light having a luminance that is in accordance with a brightness of video to be displayed in that segmental area.

Another configuration of the liquid crystal display device in accordance with the present invention further includes a first gray level correction table and a second gray level correction table representing a greater output dynamic range than does the first gray level correction table, Wherein either the first or the second gray level correction table or both is/are applied to the gray level data depending on the saturation index for the first pixel, to perform saturation-specific gray level correction.

In another configuration of the liquid crystal display device in accordance with the present invention, the gray level data, after being subjected to the saturation-specific gray level correction, is adjusted with respect to a gray level of each segmental area in accordance with luminance of light illuminating that segmental area.

In another configuration of the liquid crystal display device in accordance with the present invention, the gray level data, after being adjusted with respect to a gray level of each segmental area in accordance with luminance of light illuminating that segmental area, is subjected to the saturation-specific gray level correction.

The present invention is directed also to a method of controlling a liquid crystal display device including picture elements each composed of first to n-th pixels, a portion of a liquid crystal layer in each pixel being rendered to exhibit an optical transmittance that is in accordance with gray level data, wherein both: a case where gray level data for the first pixel indicates a first gray level, n pieces of gray level data for the first to n-th pixels indicate a saturation index for the first pixel that has a first index value, and the first pixel exhibits an optical transmittance that is equal to a first optical transmittance; and a case where gray level data for the first pixel indicates a first gray level, a pieces of gray level data for the first to n-th pixels indicate a saturation index for the first pixel that has a second index value, and the first pixel exhibits an optical transmittance that is equal to a second optical transmittance are possible, the first gray level is included in a low gray le el region that is a first half of all gray levels that can be indicated by the gray level data, and the first index value is smaller than the second index value, and the first optical transmittance is greater than the second optical transmittance.

The present invention is not limited to the embodiments and examples above. Proper variations and combinations of the embodiments and examples in View of general technical knowledge are also encompassed in the technical scope of the present invention.

### INDUSTRIAL APPLICABILITY

The liquid crystal display device in accordance with the present invention is suitably used, for example, in liquid crystal televisions, liquid crystal monitors, and television monitors.

### REFERENCE SIGNS LIST

1 Liquid Crystal Display Device
10 Liquid Crystal Panel
11 Picture Element
20 Gate Driver
30 Source Driver
40 Backlight
50 Display Control Circuit
51 Processor
52 Memory
Rp, Gp, Bp Red Pixel, Green Pixel, Blue Pixel
Ri Gray Level Data for Red Pixel
Gi Gray Level Data for Green Pixel
Bi Gray Level Data for Blue Pixel
SR Saturation Index for Red Pixel
SG Saturation Index for Green Pixel
SB Saturation Index for Blue Pixel
LUT 1r Lookup Table 1 (First Gray Level Correction Table)
LUT 2r Lookup Table 2 (Second Gray Level Correction Table)

1. A liquid crystal display device comprising picture elements each composed of first to n-th pixels, a portion of a liquid crystal layer in each pixel being rendered to exhibit an optical transmittance that is in accordance with gray level data, wherein
both:
a case where gray level data for the first pixel indicates a first gray level, n pieces of gray level data for the first to n-th pixels indicate a saturation index for the first pixel that has a first index value, and the first pixel exhibits an optical transmittance that is equal to a first optical transmittance; and
a case where gray level data for the first pixel indicates a first gray level, n pieces of gray level data for the first to n-th pixels indicate a saturation index for the first pixel that has a second index value, and the first pixel exhibits an optical transmittance that is equal to a second optical transmittance
are possible,
the first gray level is included in a low gray level region that is a first half of all gray levels that can be indicated by the gray level data, and
the first index value is smaller than the second index value, and the first optical transmittance is greater than the second optical transmittance.

2. The liquid crystal display device according to claim 1, wherein the optical transmittance of the first pixel has a smaller dynamic range when (a) the gray level data for the first pixel is changed from a minimum to a maximum with the saturation index for the first pixel being fixed to the first index value than when (b) the gray level data for the first pixel is changed from the minimum to the maximum with the saturation index for the first pixel being fixed to the second index value.

3. The liquid crystal display device according to claim 1, wherein
the optical transmittance of the first pixel is set via a signal voltage inputted to the first pixel, and
the signal voltage inputted to the first pixel has a smaller dynamic range when (a) the gray level data for the first pixel is changed from a minimum to a maximum with the saturation index for the first pixel being fixed to the first index value than when (b) the gray level data for the first pixel is changed from the minimum to the maximum with the saturation index for the first pixel being fixed to the second index value.

4. The liquid crystal display device according to claim 1, wherein
the optical transmittance of the first pixel is set via a signal voltage inputted to the first pixel, and
the signal voltage inputted to the first pixel has a greater dynamic range when the gray level data for the first pixel is changed from a minimum to a maximum with the gray level data for the second to n-th pixels being fixed to the maximum than when the gray level data for the first pixel is changed from the minimum to the maximum with the gray level data for the second to n-th pixels being fixed to the minimum.

5. The liquid crystal display device according to claim 2, wherein
the dynamic range has a difference between (a) and (b) that corresponds to a part that corresponds to from a minimum gray level to a threshold gray level of the gray level data in (b), and
the threshold gray level is included in the low gray level region.

6. The liquid crystal display device according to claim 5, herein the threshold gray level is either equal to or lower than gray level 32 when the gray level data can indicate 256 gray levels.

7. The liquid crystal display device according to claim 5, wherein an optical transmittance that corresponds to the threshold gray level is less than or equal to 1% of an optical transmittance that corresponds to a maximum gray level.

8. The liquid crystal display device according to claim 7, wherein the optical transmittance that corresponds to the threshold gray level is greater than or equal to 0.1% and less than or equal to 1% of the optical transmittance that corresponds to the maximum gray level.

9. The liquid crystal display device according to claim 1, wherein the saturation index for the first pixel is determined using a relationship between the n pieces of gray level data for the first to n-th pixels and the gray level data for the first pixel.

10. The liquid crystal display device according to claim 1, wherein the saturation index for the first pixel is determined using a relationship between a maximum value and a minimum value indicated by the n pieces of gray level data for the first to n-th pixels.

11. The liquid crystal display device according to claim 1, further comprising a backlight that shines light onto a liquid crystal panel divided into a plurality of segmental areas, wherein the backlight is controlled so as to illuminate each individual segmental area with light having a luminance that is in accordance with a brightness of video to be displayed in that segmental area.

12. The liquid crystal display device according to claim 11, further comprising a first gray level correction table and a second gray level correction table representing a greater output dynamic range than does the first gray level correction table, wherein either the first or the second gray level correction table or both is/are applied to the gray level data depending on the saturation index for the first pixel, to perform saturation-specific gray level correction.

13. The liquid crystal display device according to claim 12, wherein the gray level data, after being subjected to the saturation-specific gray level correction, is adjusted with respect to a gray level of each segmental area in accordance with luminance of light illuminating that segmental area.

14. The liquid crystal display device according to claim 12, wherein the gray level data, after being adjusted with respect to a gray level of each segmental area in accordance with luminance of light illuminating that segmental area, is subjected to the saturation-specific gray level correction.

15. A method of controlling a liquid crystal display device comprising picture elements each composed of first to n-th pixels, a portion of a liquid crystal layer in each pixel being rendered to exhibit an optical transmittance that is in accordance with gray level data, wherein
both:
a case where gray level data for the first pixel indicates a first gray level, n pieces of gray level data for the first to n-th pixels indicate a saturation index for the first pixel that has a first index value, and the first pixel exhibits an optical transmittance that is equal to a first optical transmittance; and
a case where gray level data for the first pixel indicates a first gray level, n pieces of gray level data for the first to n-th pixels indicate a saturation index for the first pixel that has a second index value, and the first pixel exhibits an optical transmittance that is equal to a second optical transmittance
are possible,
the first gray level is included in a low gray level region that is a first half of all gray levels that can be indicated by the gray level data, and
the first index value is smaller than the second index value, and the first optical transmittance is greater than the second optical transmittance.
